(19) United States
(12) Patent Application Publication
(10) Pub. No.: US 2019/0146994 A1
(43) Pub. Date: May 16, 2019

(54) SYSTEM FOR DETERMINING USER EXPOSURE TO AUDIO FRAGMENTS

(71) Applicant: AudioCoup B.V., Sint Michielsgestel (NL)

(72) Inventor: Stefan Petrus Reinier Maria VERHAGEN, Sint Michielsgestel (NL)

(73) Assignee: AudioCoup B.V., Sint Michielsgestel (NL)

(21) Appl. No.: 16/300,145

(22) PCT Filed: May 9, 2017
(86) PCT No.: PCT/NL2017/050289

§ 371 Date: Nov. 9, 2018

(30) Foreign Application Priority Data
May 9, 2016 (NL) 2016742

(51) Int. Cl. G06F 16/64; G06F 16/638; G10L 15/22; G10L 15/26

(52) U.S. Cl. CPC G06F 16/64; G10L 15/265; G10L 15/22; G06F 16/638

(57) ABSTRACT

System for determing user exposure to audio fragments. The system includes a first database including data representative of a plurality of audio fragments, each audio fragment having at least one fingerprint associated therewith, a user device including a microphone, a triggering unit and a communications unit, wherein the user device is arranged for receiving a trigger, after having received the trigger recording ambient sound, determining at least one fingerprint for the recorded sound, and communicating with the first database for identifying which audio fragment of the plurality of audio fragments is included in the recorded ambient sound, and a second database, wherein the user device is arranged for communicating with the second database for storing therein data representative of the audio fragment having been identified.

### FIELD OF THE INVENTION

The invention relates to automated recognition of audio fragments.

### BACKGROUND TO THE INVENTION

It is known to automatically recognize an audio fragment by determining one or more fingerprints of the audio fragment and comparing these with fingerprints of known audio fragments in a database. One of such technologies is described in U.S. Pat. No. 6,990,453 B2.

### SUMMARY OF THE INVENTION

It is an object to provide more useful and/or interactive use of recognizing audio fragments and/or audiovisual fragments.

Thereto, according to an aspect is provided a system for determining user exposure to audio fragments. The system includes a first database including data representative of a plurality of audio fragments, each audio fragment having at least one fingerprint associated therewith. The system includes a user device, such as a mobile user device. The user device can e.g. be a smart phone. The user device can include a microphone, a triggering unit and a communications unit. The user device is arranged for receiving a trigger. After having received the trigger the user device is arranged to record ambient sound. The user device is arranged to determine at least one fingerprint for the recorded sound. The user device communicates with the first database for identifying which audio fragment of the plurality of audio fragments is included in the recorded ambient sound. The system includes a second database. The user device is arranged for communicating with the second database for storing therein data representative of the identified audio fragment having been heard.

Hence, the user device can be triggered, e.g. externally or internally, to start listening to ambient sound and automatically checks for potential audio fragments included in the first database. It will be appreciated that the first database need not include the full audio fragments, it can also include data representative of the audio fragments, such as one or more fingerprints and e.g. an identification of the audio fragment. It will be appreciated that the first database can be internal to the user device and/or external to the user device, e.g. at an internet server. If it has been determined that the user device has listened to an audio fragment included in the first database, a note of this can be made in the second database. The note can include the identified audio fragment and/or an identification thereof. The note can include a time of the identified audio fragment having been heard. The note can include an identification of the user and/or user device. The note can include information relating to the circumstances under which the identified audio fragment was heard, e.g. noisy background, quiet background, a location of the user device (e.g. GPS) when the fragment was heard, an indication of movement of the user device while the fragment was heard, connection of the user device to other devices while the fragment was heard (e.g. WiFi of a home router, Bluetooth of a car), which app was active on the user device.

Optionally, the fingerprint includes one or more parameters representative of the audio fragment. The parameters can include a (relative) volume, pitch, and/or spectrum. The fingerprint can include a time evolution of the one or more parameters.

Optionally, the fingerprint includes a spectral slice fingerprint, a multi-slice fingerprint, an LPC coefficient, a cepstral coefficient, frequency components of a spectrogram peak, or a combination thereof. Optionally, the fingerprint includes a time evolution of a spectral slice fingerprint, a multi-slice fingerprint, an LPC coefficient, a cepstral coefficient, frequency components of a spectrogram peak, or a combination thereof.

Optionally, the fingerprint includes a transcription of a speech fragment included in the audio fragment. The transcription is representative for the speech fragment.

Optionally, the identifying which audio fragment of the plurality of audio fragments is included in the recorded ambient sound includes comparing the at least one fingerprint of the recorded sound with the at least one fingerprint of each of the audio fragments of the plurality of audio fragments. The identifying can include selecting the audio fragment of the plurality of audio fragments of which the at least one fingerprint best matches the at least one fingerprint of the recorded sound.

The audio fragment can include an audiovisual fragment, such as a video fragment including an audio track. The audio fragment can e.g. be a commercial. The first database can e.g. include data representative of a plurality of commercials.

Optionally, the system includes a broadcasting unit for broadcasting one or more audio fragments of the plurality of audio fragments. The broadcasting unit can e.g. be a radio station, television station, internet server, environmental broadcast unit in a store or the like.

Optionally, the system includes a trigger transmitter arranged for transmitting the trigger to the user device. The trigger transmitter can e.g. be an internet server, a telecommunications server, a GPS satellite, a beacon or the like.

Optionally, the trigger transmitter is arranged for receiving a broadcast audio fragment, determining whether the received audio fragment corresponds to an audio fragment of the plurality of audio fragments and if the received audio fragment corresponds to an audio fragment of the plurality of audio fragments transmitting the trigger to the user device. Hence the trigger transmitter can, e.g. continuously, check whether an audio fragment of the plurality of audio fragments is being broadcast. Once the trigger transmitter determines that one such audio fragment is being broadcast, it can trigger the user device, or a plurality of user devices, to start listening whether the user device(s) hear the audio fragment as well. The trigger transmitter may e.g. monitor a radio channel or a television channel to check whether one or more commercials included in the first database are being broadcast. Once the trigger transmitter detects such commercial, it can trigger user devices to check whether they hear the commercial as well.

Optionally the user device includes a Speech-To-Text, STT, unit for converting the recorded sound to text. The first database may include text fragments associated with audio fragments via STT when the text fragments are spoken. The user device may record ambient sound and convert it into text using the STT unit. It can then be determined whether the recorded ambient sound includes one or more of the text fragments included in the first database.

Optionally, the user device is arranged for receiving a trigger in the form of a transmission, a geolocation, a beacon, shaking of the user device, a predetermined time, a predetermined time interval, a keyword, a button activation, a touch activation, a cue sheet, or the like.

Optionally, the user device is arranged for in response to identifying which audio fragment of the plurality of audio fragments is included in the recorded ambient sound directing a web navigation to a predetermined URL.

Optionally, the user device has a user account associated therewith, wherein in response to the user device storing in the second database the data representative of the identified audio fragment having been heard credits are assigned to the user account. It is for example possible that the user that heard a certain commercial (as determined by his user device) is eligible for a discount or cashback is provided.

According to an aspect is provided a user device for determining user exposure to audio fragments. The user device includes a microphone, a triggering unit and a communications unit. The user device is arranged for receiving a trigger. The user device is arranged for after having received the trigger recording ambient sound, determining at least one fingerprint for the recorded sound, and communicating with a first database, including data representative of a plurality of audio fragments, each audio fragment having at least one fingerprint associated therewith, for identifying which audio fragment of the plurality of audio fragments is included in the recorded ambient sound. The user device is arranged for communicating with a second database for storing therein data representative of the identified audio fragment having been heard. The user device can be a mobile user device, such as a smart phone having dedicated software, such as an app, installed and running thereon.

Optionally, the user device includes or is in communication with a Speech-To-Text unit, STT, for converting the recorded sound to text.

Optionally, the user device is arranged for receiving a trigger in the form of a transmission, a geolocation, a beacon, shaking of the user device, a predetermined time, a predetermined time interval, a keyword, a button activation, a touch activation, a cue sheet, or the like.

Optionally, the user device is arranged for communicating with the second database for storing therein, in relation to the data representative of the identified audio fragment having been heard, one or more of a time of the identified audio fragment having been heard, an identification of the user and/or user device.

According to an aspect is provided a trigger transmitter is arranged for receiving a broadcast audio fragment, further arranged for communicating with a first database including data representative of a plurality of audio fragments, each audio fragment having at least one fingerprint associated therewith. The trigger transmitter is arranged for determining whether the received audio fragment corresponds to an audio fragment of the plurality of audio fragments and if the received audio fragment corresponds to an audio fragment of the plurality of audio fragments transmitting a trigger to a user device.

According to an aspect is provided a method for determining user exposure to audio fragments using a user device. The method includes: receiving a trigger; after having received the trigger recording ambient sound; determining at least one fingerprint for the recorded sound; communicating with a first database, including data representative of a plurality of audio fragments, each audio fragment having at least one fingerprint associated therewith, for identifying which audio fragment of the plurality of audio fragments is included in the recorded ambient sound; and communicating with a second database for storing therein data representative of the identified audio fragment having been heard.

According to an aspect is provided a computer program product including software code portions which, when run on a programmable apparatus, cause the apparatus to be ready to receive a trigger; after having received the trigger record ambient sound; determine at least one fingerprint for the recorded sound; communicate with a first database, including data representative of a plurality of audio fragments, each audio fragment having at least one fingerprint associated therewith, for identifying which audio fragment of the plurality of audio fragments is included in the recorded ambient sound; and communicate with a second database for storing therein data representative of the identified audio fragment having been heard. The computer program product can e.g. be an app designed to be run on a mobile device such as a smart phone, tablet, or vehicle such as a car. The computer program product can be included on a non-transitory storage medium.

It will be appreciated that any of the aspects, features and options described in view of the system apply equally to the user device, trigger transmitter, method and computer program product. It will also be clear that any one or more of the above aspects, features and options can be combined.

### BRIEF DESCRIPTION OF THE DRAWING

The invention will further be elucidated on the basis of exemplary embodiments which are represented in a drawing. The exemplary embodiments are given by way of non-limitative illustration. It is noted that the figures are only schematic representations of embodiments of the invention that are given by way of non-limiting example.

In the drawing:

FIG. 1 shows a schematic representation of a system for determining user exposure to audio fragments;

FIG. 2 shows a schematic representation of a system for determining user exposure to audio fragments, and

FIG. 3 shows a schematic representation of a system for determining user exposure to audio fragments.

### DETAILED DESCRIPTION

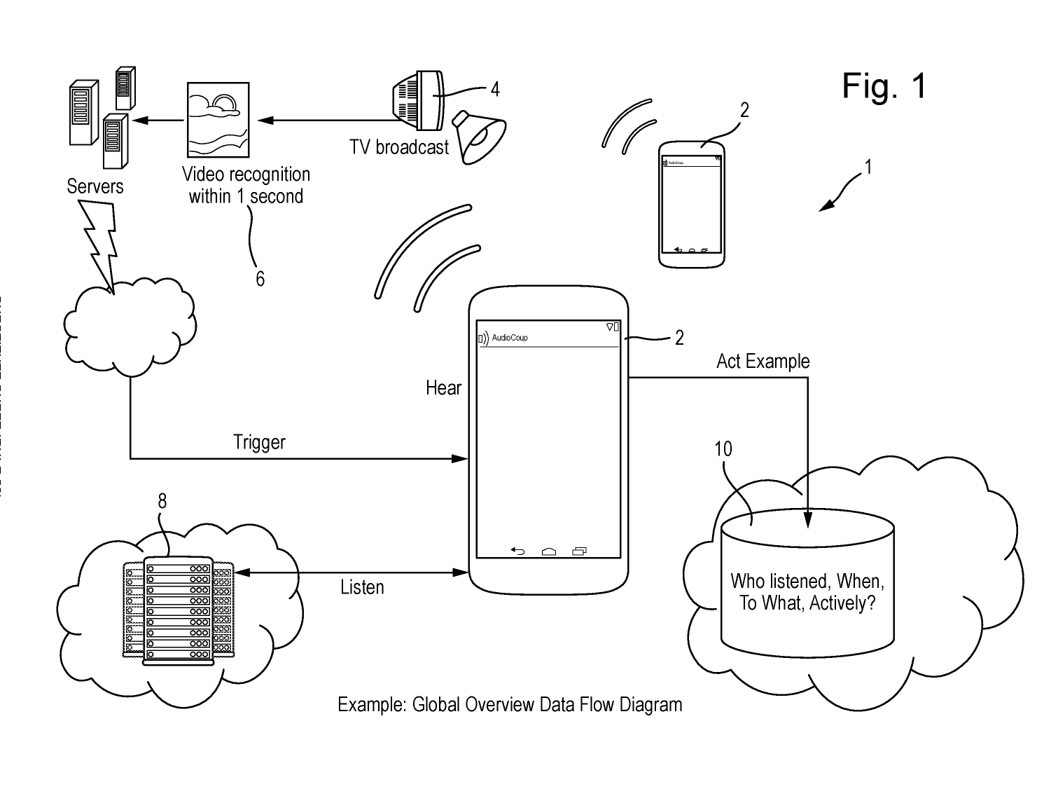

FIG. 1 shows a schematic representation of a system 1 for determining user exposure to audio fragments. The system 1 includes a user device 2. It will be appreciated that the system 1 may include a plurality of user devices 2. In this example, the system 1 further includes a broadcasting unit 4, here in the form of a television broadcasting station. In this example the broadcasting station broadcasts programming of a television channel. The programming includes audiovisual fragments. The audiovisual fragments may e.g. relate to programs, such as shows, movies, sports registrations, news programs and the like. Some of the audiovisual fragments may relate to commercials.

The system 1 includes a trigger transmitter 6. Here the trigger transmitter includes an internet server. The trigger transmitter 6 monitors television channel broadcasts by the broadcasting unit 4. Here the trigger transmitter 6 monitors television channel broadcasts by the broadcasting unit 4 continuously. The trigger transmitter 6 can monitor one or a plurality of television channels simultaneously. The trigger transmitter 6 is arranged for recognizing certain audiovisual fragments in the programming of the television channel. Here, the trigger transmitter 6 performs video recognition on the broadcasted videos. The trigger transmitter 6 has a trigger database associated therewith which includes a plurality of audiovisual fragments (or data representative thereof) which the trigger transmitter 6 is to recognize. Once the trigger transmitter recognizes one of the audiovisual fragments included in the trigger database being broadcast, it generates a trigger which is transmitted to the user devices 2. In this example the audiovisual fragments in the trigger database relate to commercials.

The user device 2 in this example runs an app causing it to activate upon receipt of a trigger from the trigger transmitter 6. It will be appreciated that the app may thereto remain active in the background of the user device. When activated the user device 2 starts listening. The user device 2 records ambient sound using a, e.g. built in, microphone. If the user device 2 is in the neighborhood of a television set tuned to any television channel monitored by the trigger transmitter 6 it may record an audio fragment associated with the television programming of the monitored channel. The user device 2 determines one or more fingerprints for the audio being recorded. The user device 2 communicates with an audio fragment database 8. The audio fragment database 8 includes data representative of a plurality of audio fragments, each audio fragment having at least one fingerprint associated therewith. In this example the audio fragments in the audio fragment database relate to commercials, e.g. to audio tracks of television commercials. The fingerprint(s) determined by the user device 2 is compared with fingerprints in the audio fragment database 8. This comparing can be done by the user device 2 and/or by an internet server. If a match is found, it is determined that the associated audio fragment in the audio fragment database 8 has been heard by the user device 2.

The user device 2 then communicates with a result database 10. The user device 2 transmits to the result database 10, for storing therein, an indication that the identified audio fragment has been heard. The indication may include data representative of the identified audio fragment. The indication can include a time of the identified audio fragment having been heard. The indication can include an identification of the user and/or user device. The indication can include information relating to the circumstances under which the identified audio fragment was heard, e.g. noisy background, quiet background, a location of the user device (e.g. GPS) when the fragment was heard, an indication of movement of the user device while the fragment was heard, connection of the user device to other devices while the fragment was heard (e.g. WiFi of a home router, Bluetooth of a car), or which app was active on the user device.

Thus, in this example the result database 10 includes data representative of commercials having been heard by user devices 2. In response to the user device 2 hearing an audio fragment included in the audio fragment database actions can be taken. An internet browser on the user device 2 may automatically be directed to a predetermined URL, e.g. related to the commercial. An offer may be made to the user of the user device 2. A credit may be awarded to the user of the user device, such as a discount a store credit or a cashback.

After the user device 2 has been triggered, it may remain active, i.e. recording ambient sound for a predetermined time. It is also possible that the user device remains active as long as it recognizes audio fragments. It is also possible that the user device remains active for a predetermined time after having last recognized an audio fragment.

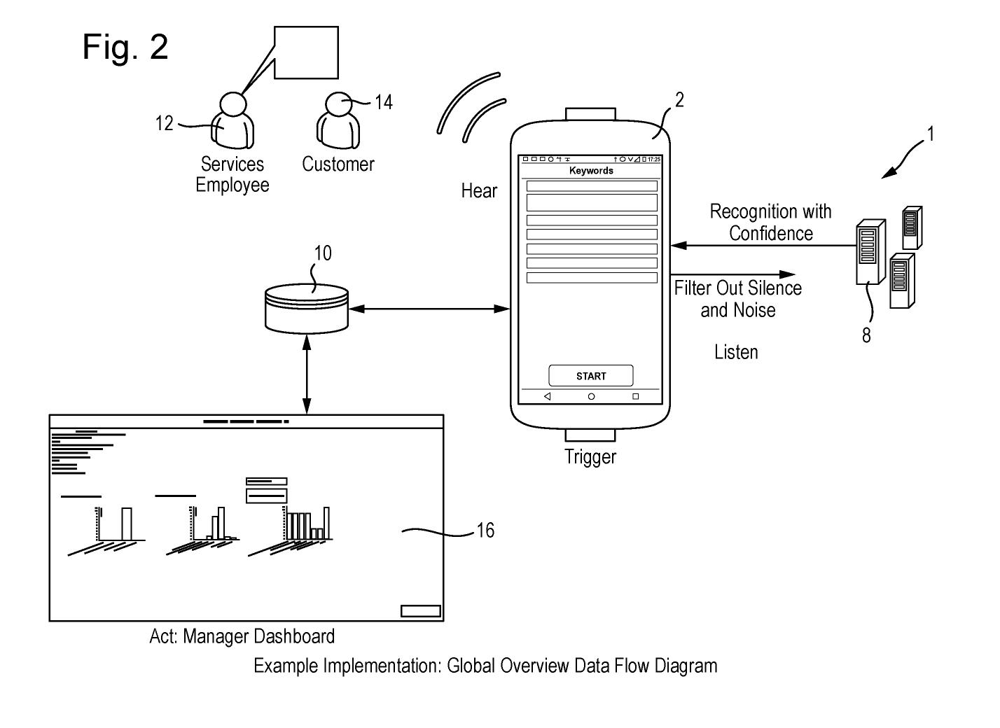

FIG. 2 shows a schematic representation of a system 1 for determining user exposure to audio fragments. The system 1 includes a user device 2. It will be appreciated that the system 1 may include a plurality of user devices 2. In this example, the user device is triggered manually, e.g. by pressing a button on the device 2 or by touch interaction with a touch screen of the device 2. In this example the user device 2 is associated with a service employee 12. The service employee 12 may e.g. trigger the device 2 when approaching a customer 14.

After triggering the user device 2 records ambient sound. The ambient sound can include a conversation between the service employee 12 and the customer 14. The user device 2 determines fingerprints for fragments of the recorded audio. In this example the audio fragment database 8 includes predetermined sentences the service employee 12 may speak to the customer 14 such as “would you like a cup of coffee?”, “would you like to use our restaurant?”, “do you know our special offer?”, “do you already have coupons?”, “cola”, “coffee with cake”, “coffee with sugar”, or the like. Each predetermined sentence has at least one fingerprint associated therewith. In this example it is determined whether fragments of the recorded audio correspond to one or more of the predetermined sentences stored in database 10. If one of the predetermined sentences has been identified in the recorded audio, an indication thereof is stored in the result database 10. The indication may include an indication of the identity of the service employee, a time and/or date, a location in a store, or the like. In this example, the system 1 includes a manager dashboard 16. The manager dashboard can be a graphical user interface. The manager dashboard 16 can present results included in the result database 10, statistics on the results and the like.

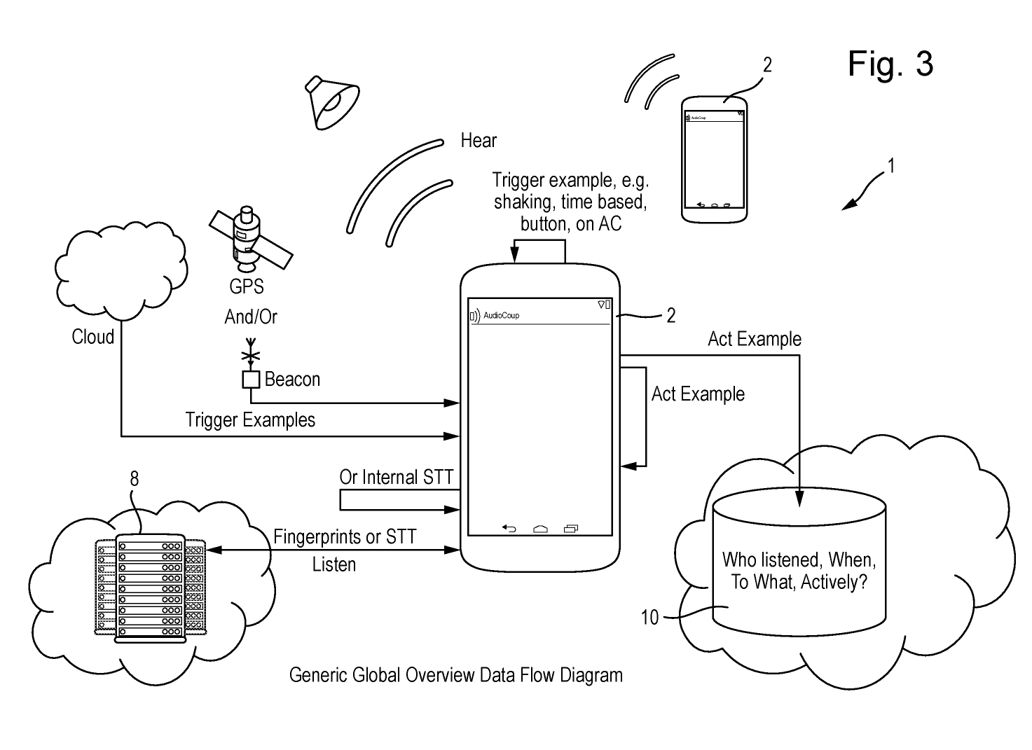

FIG. 3 shows a schematic representation of a system 1 for determining user exposure to audio fragments. The system 1 includes a user device 2. It will be appreciated that the system 1 may include a plurality of user devices 2. In this example, the user device is triggered by GPS signal or a beacon or from the cloud. Alternatively, or additionally, the user device 2 may be triggered manually, e.g. by shaking the device 2 and/or by pressing a button. It is also possible that the user device 2 is arranged to continuously listens to ambient sound, e.g. when the user device is connected to an external power source such as a wall outlet socket.. Alternatively, or additionally, the user device 2 may be triggered on time basis.

After triggering the user device 2 records ambient sound. The ambient sound can include television programming, radio programming, commercials in a cinema, commercials in a shop, or the like. The user device determines at least one fingerprint for the recorded sound. In this example the audio fragment database 8 includes audio fragments related to commercials. In this example it is determined whether fragments of the recorded audio correspond to one or more of the audio fragments in the audio fragment database.

Alternatively, or additionally, the user device 2 can include a Speech-To-Text, STT, unit arranged for converting recorded speech into text. The STT unit transcribes the recorded speech to a text string. The audio fragment database 8 can thereto includes text strings representative of the audio fragments. The text strings here form the fingerprint representative of the audio fragments and the recorded speech. Comparing of the fingerprints can then include comparing of text string of the recorded speech with the text strings of the audio fragments in the database.

If one of the audio fragments has been identified in the recorded audio, an indication thereof is stored in the result database 10. The indication may include an indication of the identity of the user and/or user device, a time and/or date, a location, or the like.

Herein, the invention is described with reference to specific examples of embodiments of the invention. It will, however, be evident that various modifications and changes may be made therein, without departing from the essence of the invention. For the purpose of clarity and a concise description features are described herein as part of the same or separate embodiments, however, alternative embodiments having combinations of all or some of the features described in these separate embodiments are also envisaged.

In this examples the trigger transmitter monitors the television channels on the basis of video recognition. It is noted that it is also possible that the trigger transmitter monitors the television channels on the basis of recognition of audio fragments. It is also possible that the trigger transmitter is arranged for detecting the onset of a commercial block in the programming

It is possible that the trigger database and the audio fragment database are one and the same.

In the example of FIG. 1 the user device is triggered by the trigger transmitter. It will be appreciated that also alternative trigger mechanisms are possible such as the device being at a predetermined geolocation, the device identifying a beacon, shaking of the user device, a predetermined time, a predetermined time interval, a keyword, a button activation, a touch activation, a cue sheet, or the like.

In the example of FIG. 2 the audio fragment database includes predetermined sentences. It will be appreciated that the audio fragment database may also include fingerprints associated with the predetermined sentences without actually including the predetermined sentences. It will be appreciated that it is also possible that the audio fragment database includes text sentences representative of the spoken sentences, and that the user device uses the STT unit for converting recorded fragments of a conversation to text as described in view of FIG. 3. Comparing of the fingerprints can then include comparing of text strings.

However, other modifications, variations, and alternatives are also possible. The specifications, drawings and examples are, accordingly, to be regarded in an illustrative sense rather than in a restrictive sense.

For the purpose of clarity and a concise description features are described herein as part of the same or separate embodiments, however, it will be appreciated that the scope of the invention may include embodiments having combinations of all or some of the features described.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

1. System for determining user exposure to audio fragments, including:
a first database including data representative of a plurality of audio fragments, each audio fragment having at least one fingerprint associated therewith;
a user device including a microphone, a triggering unit and a communications unit, wherein the user device is arranged for receiving a trigger, after having received the trigger recording ambient sound, determining at least one fingerprint for the recorded sound, and communicating with the first database for identifying which audio fragment of the plurality of audio fragments is included in the recorded ambient sound; and
a second database, wherein the user device is arranged for communicating with the second database for storing therein data representative of the identified audio fragment having been heard.

2. System according to claim 1, further including a broadcasting unit for broadcasting one or more audio fragments of the plurality of audio fragments.

3. System according to claim 1, further including a trigger transmitter arranged for transmitting the trigger to the user device.

4. System according to claim 2, wherein the trigger transmitter is arranged for receiving a broadcast audio fragment, determining whether the received audio fragment corresponds to an audio fragment of the plurality of audio fragments and if the received audio fragment corresponds to an audio fragment of the plurality of audio fragments transmitting the trigger to the user device.

5. System according to claim 1, wherein the audio fragment includes an audiovisual fragment.

6. System according to claim 1, wherein the fingerprint includes one or more parameters representative of the audio fragment, such as a volume, a relative volume, a pitch, and/or a spectrum, and/or a time evolution of the one or more parameters.

7. System according to claim 1, wherein the fingerprint includes a spectral slice fingerprint, a multi-slice fingerprint, an LPC coefficient, a cepstral coefficient, frequency components of a spectrogram peak, or a combination thereof, and/or a time evolution thereof.

8. System according to claim 1, wherein the fingerprint includes a transcription of a speech fragment included in the audio fragment.

9. System according to claim 1, wherein the user device includes a Speech-To-Text unit, STT, for converting the recorded sound to text.

10. System according to claim 1, wherein the user device is arranged for receiving a trigger in the form of a transmission, a geolocation, a beacon, shaking of the user device, a predetermined time, a predetermined time interval, a keyword, a button activation, a touch activation, a cue sheet, or the like.

11. System according to claim 1, wherein the user device is arranged for communicating with the second database for storing therein, in relation to the data representative of the identified audio fragment having been heard, one or more of a time of the identified audio fragment having been heard, an identification of the user and/or user device.

12. System according to claim 1, wherein the user device has a user account associated therewith, wherein in response to the user device storing in the second database the data representative of the identified audio fragment having been heard credits are assigned to the user account.

13. User device for determining user exposure to audio fragments, including:
a microphone, a triggering unit and a communications unit, wherein the user device is arranged for receiving a trigger, after having received the trigger recording ambient sound, determining at least one fingerprint for the recorded sound, and communicating with a first database, including data representative of a plurality of audio fragments, each audio fragment having at least one fingerprint associated therewith, for identifying which audio fragment of the plurality of audio fragments is included in the recorded ambient sound;
the user device being arranged for communicating with a second database for storing therein data representative of the identified audio fragment having been heard.

14. User device according to claim 13, including a Speech-To-Text unit, STT, for converting the recorded sound to text.

15. User device according to claim 13, wherein the user device is arranged for receiving a trigger in the form of a transmission, a geolocation, a beacon, shaking of the user device, a predetermined time, a predetermined time interval, a keyword, a button activation, a touch activation, a cue sheet, or the like.

16. User device according to claim 13, wherein the user device is arranged for communicating with the second database for storing therein, in relation to the data representative of the identified audio fragment having been heard, one or more of a time of the identified audio fragment having been heard, an identification of the user and/or user device.

17. Trigger transmitter is arranged for receiving a broadcast audio fragment, further arranged for communicating with a first database including data representative of a plurality of audio fragments, each audio fragment having at least one fingerprint associated therewith,
the trigger transmitter being arranged for determining whether the received audio fragment corresponds to an audio fragment of the plurality of audio fragments and if the received audio fragment corresponds to an audio fragment of the plurality of audio fragments transmitting a trigger to a user device.

18. Method for determining user exposure to audio fragments using a user device, including:
receiving a trigger,
after having received the trigger recording ambient sound,
determining at least one fingerprint for the recorded sound,
communicating with a first database, including data representative of a plurality of audio fragments, each audio fragment having at least one fingerprint associated therewith, for identifying which audio fragment of the plurality of audio fragments is included in the recorded ambient sound; and
communicating with a second database for storing therein data representative of the identified audio fragment having been heard.

19. Computer program product including software code portions which, when run on a programmable apparatus, cause the apparatus to:
be ready to receive a trigger,
after having received the trigger record ambient sound,
determine at least one fingerprint for the recorded sound,
communicate with a first database, including data representative of a plurality of audio fragments, each audio fragment having at least one fingerprint associated therewith, for identifying which audio fragment of the plurality of audio fragments is included in the recorded ambient sound; and
communicate with a second database for storing therein data representative of the identified audio fragment having been heard.
